(19) United States
(12) Patent Application Publication
(10) Pub. No.: US 2023/0203847 A1
(43) Pub. Date: Jun. 29, 2023

(54) LOCKING MODULE

(71) Applicant: Cheon Deok JIN, Cheongju-si, Chungcheongbuk-do (KR)

(72) Inventor: Cheon Deok JIN, Cheongju-si, Chungcheongbuk-do (KR)

(21) Appl. No.: 17/927,028

(22) PCT Filed: May 26, 2021
(86) PCT No.: PCT/KR2021/006554

§ 371 Date: Nov. 22, 2022

(30) Foreign Application Priority Data
Jun. 1, 2020 (KR) 10-2020-0065800

(51) Int. Cl. E05B 49/00; E05B 39/00; E05B 41/00; G07C 9/23; G07C 9/25; A45C 11/34; A45C 13/10

(52) U.S. Cl. CPC E05B 49/002; E05B 39/007; E05B 41/00; G07C 9/23; G07C 9/257; A45C 11/34; A45C 13/103

(57) ABSTRACT

A locking module includes: a storage unit in which a password is saved; an input unit which receives a number as an input; a locking unit which restrains a zipper and thereby restricts the sliding of the zipper in a state in which two housings are coupled through the zipper; and a control unit which, when the saved password matches the input number, transmits a lock release signal to the locking unit and controls to release the zipper restrained by the locking unit.

### TECHNICAL FIELD

The present invention relates to a locking module.

### BACKGROUND ART

In general, school supplies are purchased when entering elementary school or a new school year begins. Among the school supplies, pencil cases are used to store school supplies such as pencils and erasers. These pencil cases are released on the market in various materials and designs. The pencil cases may be classified into a plastic pencil case, a metal pencil case, and a cloth pencil case depending on a material. Plastic or metal pencil cases are bulky and have a disadvantage of generating a lot of noise while the school supplies stored therein are shaken. In addition, a cloth pencil case has an advantage in that a lot of noises are not generated even if the school supplies stored therein are shaken due to the nature of the material. For this reason, the use of the cloth pencil case rather than plastic or metal pencil cases is increasing.

On the other hand, bags such as a soft case made of a cloth material or a hard case made of a synthetic resin material such as PC or PVC have been often applied with a locking device to prevent theft of contents stored therein and the inflow of external dangerous goods. The locking device generally has a dial type or a key type.

Therefore, the pencil cases in which the school supplies are stored also require a locking device like the bags. In addition, there is a problem that dial-type or key-type locking devices distributed in the market are easily broken due to a crude structure or cannot be used due to a loss of a key.

### DISCLOSURE

### Technical Problem

It is an object of the present invention to provide a locking module provided with an electronic locking device to allow access to an internal storage space only to an owner by inputting a password.

### Technical Solution

According to an aspect of the present invention, there is disclosed a locking module.

The locking module according to the embodiment of the present invention includes a storage unit in which a password is saved; an input unit which receives a number as an input; a locking unit which restrains a zipper to restrict the sliding of the zipper in a state in which two housings are coupled through the zipper; and a control unit which, when the saved password matches the input number, transmits a lock release signal to the locking unit and controls to release the zipper restrained by the locking unit.

The locking module may be attached to a pencil case body configured so that the two hinged housings are engaged by the zipper to enable opening or closing, in which the locking module is attached to one surface of the pencil case body so as to be in contact with the zipper in order to provide a locking function through the restraint of the zipper that opens and closes the entrance of the pencil case body.

The locking module may further include a display unit, in which the control unit may output a quiz through the display unit and receive the password as an answer to the quiz to determine whether to release the lock.

When an arbitrary input signal is sensed through the input unit, the control unit may output a message to input the number of each item of objects stored in the pencil case body in sequence through the display unit, and when the number is input according to a message output, the control unit may determine whether to release the lock by determining whether the input number matches the number of each item of the stored objects in sequence.

The locking module may further include a communication unit for performing short-distance communication with a user terminal, in which the user terminal may be provided with a management application for managing the smart pencil case, and the control unit may store the item names and the number of each item of the stored objects inputted using the provided management application in the storage unit, when the user of the smart pencil case stores the objects in the pencil case body.

The locking module may further include a near field communication (NFC) reader for acquiring information stored in an NFC tag, in which a sticker including the NFC tag in which an item name corresponding to each object is stored may be attached to each object stored by the user of the smart pencil case, and the control unit may count the item names of the stored objects acquired through the NFC reader to match and store the item names and the number of each item of the stored objects in the storage unit.

The pencil case body may be formed of a cloth material, and the locking device may be formed in a rectangular plate shape having a plurality of through holes formed at regular intervals along the edge thereof, in which the locking module may be attached to the pencil case body by sewing the pencil case body with a thread through the through holes.

The locking module may further include a status display lamp for displaying a lock release state and a lock non-release state, a buzzer, and a vibration motor, in which when it is determined as the lock release, the control unit may control the lock to be released after the status display lamp, the buzzer, and the vibration motor output a predetermined lock release signal, and when it is determined as the lock non-release, the control unit may control the status display lamp, the buzzer, and the vibration motor to output a predetermined lock non-release signal.

The locking module may further include an NFC reader for acquiring information stored in a near field communication (NFC) tag or a fingerprint recognition unit for acquiring fingerprint information, in which when the NFC reader acquires authentication information from a card key including an NFC tag in which the authentication information is stored, the control unit may determine whether to release the lock by checking the acquired authentication information, or when fingerprint information is acquired by the fingerprint recognition unit, the control unit may determine whether to release the lock by checking the acquired fingerprint information.

### Advantageous Effects

According to the embodiment of the present invention, the locking module is provided with the electronic locking device to allow the access to the internal storage space only to the owner by inputting a password, thereby providing the user with a privacy protection function when using the pencil case.

### DESCRIPTION OF DRAWINGS

FIG. 1 is a perspective view schematically illustrating an appearance of a smart pencil case according to an embodiment of the present invention.

FIG. 2 is a plan view of FIG. 1.

FIG. 3 is a view schematically illustrating a configuration of a locking device of a smart pencil case according to an embodiment of the present invention.

FIG. 4 is a view for describing an operation of a smart pencil case according to an embodiment of the present invention.

### BEST MODE

A singular form used in the present specification may include a plural form unless explicitly stated otherwise in the context. In this specification, terms such as “comprising” or “including” should not be interpreted as necessarily including all various components or various steps disclosed in this specification, and it should be interpreted that some component or some steps among them may not be included or additional components or steps may be further included. In addition, terms including “unit’, “module”, and the like disclosed herein mean a unit that processes at least one function or operation, which may be implemented by hardware or software or a combination of hardware and software.

Hereinafter, various embodiments of the present invention will be described in detail with reference to the accompanying drawings.

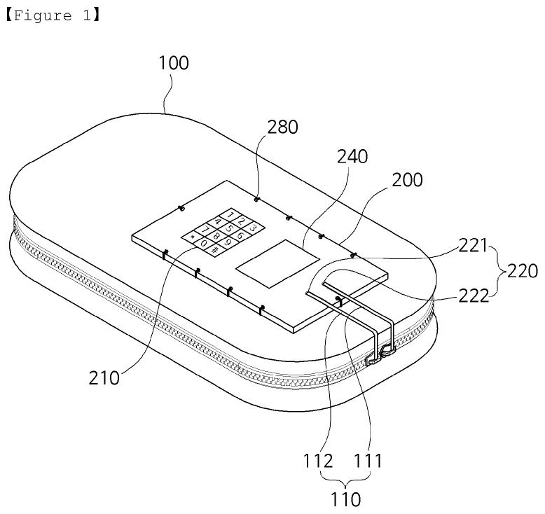

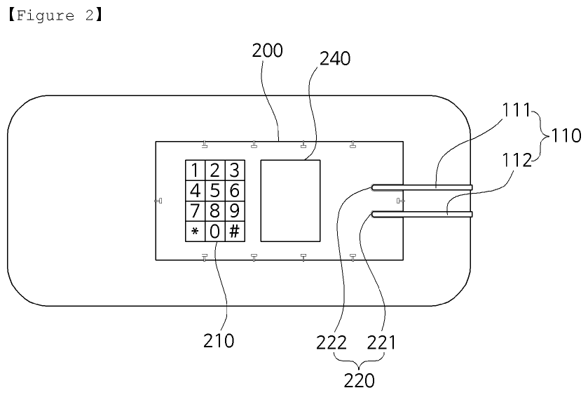

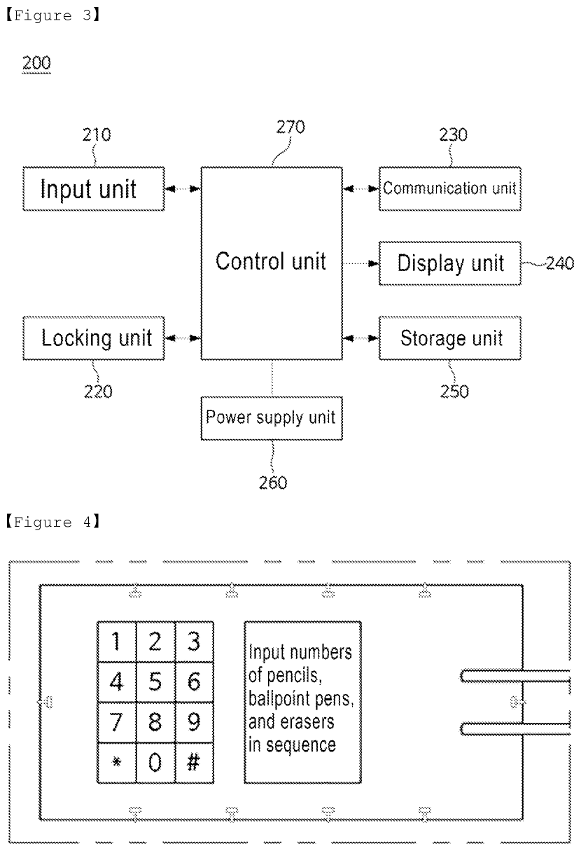

FIG. 1 is a perspective view schematically illustrating an appearance of a smart pencil case according to an embodiment of the present invention, FIG. 2 is a plan view of FIG. 1, FIG. 3 is a view schematically illustrating a configuration of a locking device of a smart pencil case according to an embodiment of the present invention, and FIG. 4 is a view for describing an operation of a smart pencil case according to an embodiment of the present invention. Hereinafter, a smart pencil case according to an embodiment of the present invention will be described with reference to FIGS. 1 to 4.

First, referring to FIGS. 1 and 2, the smart pencil case according to the embodiment of the present invention may be configured by including a pencil case body 100 in which objects are stored, and a lock device 200 for restraining a zipper 110 that opens and closes the entrance of the pencil case body 100.

The pencil case body 100 may be formed of a cloth material, and may be configured so that two hinged housings are engaged by the zipper 110 to enable opening or closing. Here, the two housings are formed of a cloth material and coupled to each other by a hinge, and the hinge may be formed to be elongated on the side surface of the pencil case body 100.

The zipper 110 slides while the two housings of the pencil case body 100 are in contact with each other to couple the two housings together.

According to the embodiment of the present invention, as illustrated in FIGS. 1 and 2, the zipper 110 may be configured in a double zipper type consisting of a first zipper 111 and a second zipper 112, which slide by facing each other in opposite directions to each other, respectively. That is, the double zipper type is provided so that the first zipper 111 and the second zipper 112 face each other, and as the first zipper 111 and the second zipper 112 approach each other, the two housings of the pencil case body 100 are coupled to each other and as the first zipper 111 and the second zipper 112 are far away from each other, the two housings are separated from each other.

For example, the first zipper 111 may be configured by including a first track and a second track formed along the edge of each housing, first teeth and second teeth formed at regular intervals on each track, a slider that engages or separates the first teeth and the second teeth while passing between the first teeth and the second teeth facing each other, and a pull tab connected to the slider. In addition, the direction of the slider of the second zipper 112 may be opposite to the direction of the slider of the first zipper 111.

However, this is only an example, and the zipper 110 is configured as one, and may be slid alone to couple and separate the two housings of the pencil case body 100 to or from each other.

Hereinafter, for convenience of description and understanding, as illustrated in FIGS. 1 and 2, it will be described that it is assumed that the zipper 110 is configured in the double zipper type including the first zipper 111 and the second zipper 112.

The locking device 200 is attached to one surface of the pencil case body 100 so as to be in contact with the zipper 110 in order to provide a locking function through restraint of the zipper 110 for opening and closing the entrance of the pencil case body 100.

That is, as illustrated in FIGS. 1 and 2, the locking device 200 may be formed in a rectangular plate shape having a predetermined thickness, and a plurality of through holes 280 may be formed at regular intervals along the edge thereof. Thus, the locking device 200 may be attached to the pencil case body 100 by sewing the pencil case body 100 made of cloth with a thread through the through holes 280.

Referring to FIG. 3, the locking device 200 may be configured by including an input unit 210, a locking unit 220, a communication unit 230, a display unit 240, a storage unit 250, a power supply unit 260 and a control unit 270.

The input unit 210 is a user interface for receiving various commands from the user, and there is no particular limitation on the implementation method.

For example, the input unit 210 may include a plurality of manipulation units, and these manipulation units may be manufactured using a key pad or a touch pad (static pressure/capacitance).

In particular, the input unit 210 may be formed of a plurality of number buttons in order to receive a password for releasing the lock.

For example, the input unit 210 may be composed of 12 buttons of 3*4 corresponding to the numbers 0 to 9 and symbols of * and #, as illustrated in FIGS. 1 and 2.

The locking unit 220 restricts the sliding of the zipper 110 by restraining the zipper 110 while the two housings of the pencil case body 100 are coupled to each other through the zipper 110.

Referring to FIGS. 1 and 2, the locking unit 220 may be configured by including tab fixing slots 221 and 222 into which the through holes formed in the pull tab of the zipper 110 are inserted and fixed. For example, a fixing module (not illustrated) for fixing or separating the zipper 110 by using the through holes of the inserted pull tab may be configured in the tab fixing slots 221 and 222. Here, the fixing module may be configured by including an engaging unit for passing through the through holes formed in the inserted pull tab, and a discharge unit that pushes the inserted pull tab to the outside while moving the engaging unit according to the control of a control unit 270 to be described below, that is, by a lock release signal of the control unit 170.

The communication unit 230 performs short-range communication with a user terminal.

For example, the communication unit 230 may transmit/receive data to and from the user terminal such as a smart phone or a desktop PC using Bluetooth or Wi-Fi.

The display unit 240 displays and outputs information received, transmitted/received, and processed by the locking device 200 according to the embodiment of the present invention. For example, the display unit 240 may be formed adjacent to the input unit 210 on one surface of the locking device 200, as illustrated in FIGS. 1 and 2, and may be implemented by a liquid crystal display or organic light emitting diodes (OLED).

The storage unit 250 may store programs for the operation of the control unit 270 (e.g., programs for determining whether to release the lock by receiving a password and controlling the locking unit 220 for releasing the lock) and may also store data processed by the control unit 270.

The power supply unit 260 is a component for supplying power to each component of the locking device 200 according to the embodiment of the present invention. For example, the power supply unit 260 may include a battery, and may also be configured by including a rechargeable battery and a charging module for charging the battery.

The control unit 270 basically controls the overall operation of the locking device 200 according to the embodiment of the present invention.

That is, when the number is input by the input unit 210, the control unit 270 determines whether to release the lock by comparing the input number with a password pre-saved in the storage unit 250, and when it is determined that the lock is released by matching the input number with the pre-saved password, the control unit 270 controls the locking unit 220 to release the zipper 110 restrained to the tab fixing slots 221 and 222 by transmitting the lock release signal to the locking unit 220.

According to another embodiment, the control unit 270 may output a quiz through the display unit 240 and receive a password as an answer to the quiz to determine whether to release the lock.

For example, when an arbitrary input signal is initially sensed through the input unit 210, as illustrated in FIG. 4, the control unit 270 may output a message to input the number of each item of objects stored in the pencil case body 100 in sequence through the display unit 240. Thereafter, when the number is input through the input unit 210 according to a message output, the control unit 270 may determine whether to release the lock by determining whether the input number matches the number of each item of the objects stored in the pencil case body 100 in sequence.

To this end, the item names and the number of each item of the stored objects may be stored in the storage unit 250 in advance.

For example, after the user connects the user terminal and the locking device 200 through short-distance communication, the item names and the number of each item of the objects stored in the pencil case body 100 are input to the locking device 200 using the user terminal to be stored in the storage unit 250. That is, a management application for managing a smart pencil case according to the embodiment of the present invention may be provided in the user terminal, and the user may input the item names and the number of each item of the objects stored in the locking device 200 using the provided management application when the objects are stored in the pencil case body 100.

Meanwhile, according to yet another embodiment, the communication unit 230 as a short-range communication module may further include a near field communication (NFC) reader for acquiring information stored in an NFC tag.

For example, when selling the smart pencil case according to the embodiment of the present invention, an NFC tag sticker stored with item names, such as pencils or erasers, may be provided, and after the user attaches the NFC tag sticker corresponding to each object to be stored, the objects attached with the NFC tag sticker may be stored in the pencil case body 100. Accordingly, the control unit 270 of the locking device 200 may count the item names of the stored objects acquired through the NFC reader of the communication unit 230 to match and store the item names and the number of each item of the objects stored in the storage unit 250.

In addition, the NFC reader may be used for releasing the lock.

For example, when the NFC reader acquires authentication information from a card key including an NFC tag in which the authentication information is stored, the control unit 270 may determine whether to release the lock by checking the acquired authentication information.

Meanwhile, although not illustrated in the drawings, the locking device 200 according to the embodiment of the present invention may further include a fingerprint recognition unit, a status display lamp, a buzzer, and a vibration motor.

That is, the fingerprint recognition unit may be used for releasing the lock. When fingerprint information is acquired by the fingerprint recognition unit, the control unit 270 may determine whether to release the lock by checking the acquired fingerprint information.

In addition, the status display lamp, the buzzer, and the vibration motor may be used to display a lock release state and a lock non-release state.

For example, when it is determined as the lock release, the control unit 270 may control the lock to be released after the status display lamp, the buzzer, and the vibration motor output a predetermined lock release signal, and when it is determined as the lock non-release, the control unit 270 may control the status display lamp, the buzzer, and the vibration motor to output a predetermined lock non-release signal.

The embodiments of the present invention described above are disclosed for purposes of illustration, and it will be apparent to those skilled in the art that various modifications, additions, and substitutions are possible within the spirit and scope of the present invention and these modifications, changes, and additions should be considered as falling within the scope of the following claims.

1. A locking module, comprising:
a storage unit in which a password is saved;
an input unit which receives a number as an input;
a locking unit which restrains a zipper to restrict the sliding of the zipper in a state in which two housings are coupled through the zipper; and
a control unit which, when the saved password matches the input number, transmits a lock release signal to the locking unit and controls to release the zipper restrained by the locking unit.

2. The locking module of claim 1, wherein the locking module is attached to a pencil case body configured so that the two hinged housings are engaged by the zipper to enable opening or closing,
wherein the locking module is attached to one surface of the pencil case body so as to be in contact with the zipper in order to provide a locking function through the restraint of the zipper that opens and closes the entrance of the pencil case body.

3. The locking module of claim 2, further comprising:
a display unit,
wherein the control unit outputs a quiz through the display unit and receives the password as an answer to the quiz to determine whether to release the lock.

4. The locking module of claim 3, wherein when an arbitrary input signal is sensed through the input unit, the control unit outputs a message to input the number of each item of objects stored in the pencil case body in sequence through the display unit, and when the number is input according to a message output, the control unit determines whether to release the lock by determining whether the input number matches the number of each item of the stored objects in sequence.

5. The locking module of claim 2, further comprising:
a communication unit for performing short-distance communication with a user terminal,
wherein the user terminal is provided with a management application for managing the smart pencil case, and
the control unit stores the item names and the number of each item of the stored objects inputted using the provided management application in the storage unit, when the user of the smart pencil case stores the objects in the pencil case body.

6. The locking module of claim 2, further comprising:
a near field communication (NFC) reader for acquiring information stored in an NFC tag,
wherein a sticker including the NFC tag in which an item name corresponding to each object is stored is attached to each object stored by the user of the smart pencil case, and
the control unit counts the item names of the stored objects acquired through the NFC reader to match and store the item names and the number of each item of the stored objects in the storage unit.

7. The locking module of claim 2, wherein the pencil case body is formed of a cloth material, and
the locking device is formed in a rectangular plate shape having a plurality of through holes formed at regular intervals along the edge thereof,
wherein the locking module is attached to the pencil case body by sewing the pencil case body with a thread through the through holes.

8. The locking module of claim 2, further comprising:
a status display lamp displaying a lock release state and a lock non-release state, a buzzer, and a vibration motor,
wherein when it is determined as the lock release, the control unit controls the lock to be released after the status display lamp, the buzzer, and the vibration motor output a predetermined lock release signal, and when it is determined as the lock non-release, the control unit controls the status display lamp, the buzzer, and the vibration motor to output a predetermined lock non-release signal.

9. The locking module of claim 2, further comprising:
an NFC reader for acquiring information stored in a near field communication (NFC) tag or a fingerprint recognition unit for acquiring fingerprint information,
wherein when the NFC reader acquires authentication information from a card key including an NFC tag in which the authentication information is stored, the control unit determines whether to release the lock by checking the acquired authentication information, or
when fingerprint information is acquired by the fingerprint recognition unit, the control unit determines whether to release the lock by checking the acquired fingerprint information.
